(19) United States
(12) Patent Application Publication
(10) Pub. No.: US 2025/0118121 A1
(43) Pub. Date: Apr. 10, 2025

(54) MECHANICAL OVERRIDE FOR ELECTRONIC LOCK

(71) Applicant: PepsiCo, Inc., Purchase, NY (US)

(72) Inventors: Cheuk Chi LAU, White Plains, NY (US); Xuejun LI, Pleasantville, NY (US); Naga Srinivas VANKADARI, White Plains, NY (US); Hilary FARNSWORTH, New Rochelle, NY (US)

(21) Appl. No.: 18/907,121

(22) Filed: Oct. 4, 2024

Related U.S. Application Data
(60) Provisional application No. 63/588,582, filed on Oct. 6, 2023.

(51) Int. Cl. G07C 9/00; G07F 17/12

(52) U.S. Cl. CPC G07C 9/00944; G07C 9/00912; G07F 17/12

(57) ABSTRACT

A lock system includes an electronic lock comprising an electronic actuator and a retainer. The electronic actuator is configured to move the retainer from a first position to a second position. The lock system also includes a mechanical lock configured to be unlocked by a key. The lock system also includes an override actuator connected to the mechanical lock and the electronic lock. The override activator is configured to move the retainer from the first position to the second position when the unlocked mechanical lock is operated.

### CROSS-REFERENCE TO RELATED APPLICATIONS

This application is a non-provisional application claiming the benefit of U.S. Provisional Application No. 63/588,582, filed Oct. 6, 2023, the entirety of which is incorporated herein by reference.

### BACKGROUND

Electronic locks have a number of useful capabilities, such as remote activation, position monitoring, and automatic controls, and are becoming increasingly common. However, electronic locks can have drawbacks compared to the mechanical locks they replace. In particular, some electronic locks become inoperable in the absence of external power. Further, many users find key-operated mechanical locks are simple to use, since an individual possessing a single key may operate any number of locks configured to be operable with that key without needing to remember codes or carry a smart device. Some varieties of electronic locks are not operable with mechanical keys, and as a result may not be compatible with workflows that users accustomed to mechanical keys would expect.

### BRIEF SUMMARY

A need exists for an electronic lock having the benefits associated with mechanical locks. Accordingly, aspects of the present disclosure are directed to an electronic lock with a mechanical override. In some such aspects, the mechanical override is a mechanical lock connected to the electronic lock by an actuator, wherein the actuator is configured to force the electronic lock into or out of a locked position in response to operation of the mechanical lock.

In some embodiments, a lock system may comprise an electronic lock comprising an electronic actuator and a retainer. The electronic actuator may be configured to move the retainer from a first position to a second position. The mechanical lock may comprise a body. The mechanical lock may be configured to transition from an immobile state to a mobile state when engaged by a key, the body is movable from a third position to a fourth position when the mechanical lock is in the mobile state. The body may not be movable from the third position to the fourth position when the mechanical lock is in the immobile state. The lock system may also comprise an override actuator connected to the mechanical lock and the electronic lock. The override actuator may be configured to move the retainer from the first position to the second position when the body moves from the third position to the fourth position.

In some embodiments according to the foregoing, the mechanical lock may comprise a lever configured to rotate when the body moves from the third position to the fourth position. The override actuator may be connected to the lever.

In some embodiments according to any of the foregoing, the override actuator may comprise a cable connected to the lever.

In some embodiments according to any of the foregoing, the override actuator may comprise a sleeve through which the cable extends such that the sleeve and the cable form a Bowden cable.

In some embodiments according to any of the foregoing, the retainer may be configured to return from the second position to the first position when the body moves from the fourth position to the third position if the electronic actuator is inactive.

In some embodiments according to any of the foregoing, the lock system may be configured to move the retainer from the second position to the first position when the body moves from the fourth position to the third position.

In some embodiments according to any of the foregoing, the retainer may be biased toward the first position.

In some embodiments according to any of the foregoing, the override actuator may be biased toward a position allowing the retainer to return from the second position to the first position.

In some embodiments according to any of the foregoing, the lock system may comprise a spring. The override actuator may comprise a cable. A bias on the override actuator may be provided by the spring acting on the cable.

In some embodiments according to any of the foregoing, a unit may comprise the lock system of claim 1. The unit may also comprise an anchor. The unit may also comprise a first portion and a second portion. The retainer may be configured to engage the anchor when the first portion contacts the second portion and the retainer is in the first position. The retainer may be configured to prevent the first portion from moving out of engagement with the second portion when the retainer engages the anchor. The retainer may be configured to disengage the anchor when the retainer moves from the first position to the second position.

In some embodiments according to any of the foregoing, the unit may be a cooler. The cooler comprise a merchandise storage space. The cooler may also comprise a payment interface. The cooler may also comprise a frame comprising the first portion of the unit. The cooler may also comprise a door comprising the second portion of the unit. The door may be configured to prevent manual access to the merchandise storage space when the retainer engages the anchor and to enable manual access to the merchandise storage space when the first portion is out of contact with the second portion.

In some embodiments according to any of the foregoing, either the first portion or the second portion may comprise the anchor. The other of the first portion or the second portion may comprise the retainer of the electronic lock.

In some embodiments according to any of the foregoing, the unit may be configured to activate the electronic actuator to move the retainer to the second position in response to receipt of a payment or payment authorization by the payment interface.

In some embodiments according to any of the foregoing, the mechanical lock may comprise a T-handle configured to rotate the body between the third position and the fourth position when the mechanical lock is in the mobile state.

In some embodiments according to any of the foregoing, the first portion may comprise a frame. The frame may comprise a track. The electronic lock may be movably mounted to the track. The electronic lock may be biased relative to the frame toward a position along the track. In some embodiments according to any of the foregoing, the first portion may comprise a frame, the electronic lock may be movably mounted to the frame, and the electronic lock may be biased relative to the frame. In some embodiments according to any of the foregoing, the anchor may be movably mounted to the door. The anchor may be biased relative to the door.

In some embodiments, an assembly may comprise an electronic lock configured to electronically move between a first state and a second state. In the first state, the electronic lock engages an anchor, and in the second state, the electronic lock does not engage the anchor. The assembly may also comprise an override comprising a mechanical linkage connected to the electronic lock. The override may be manually operable to move the electronic lock from the first state to the second state by action of the mechanical linkage.

In some embodiments according to any of the foregoing, the override may be configured to be in an inoperable state when a security token is absent. The inoperable state may prevent manual operation of the override to move the electronic lock from the first state to the second state. The override may be configured to move from the inoperable state to an operable state when the security token is presented to the override.

In some embodiments according to any of the foregoing, the security token may be a mechanical key. The override may comprise a mechanical tumbler configured complementarily to the mechanical key. The override may be configured to move from the inoperable state to the operable state when the mechanical key is presented to the override by being placed into engagement with the mechanical tumbler.

In some embodiments according to any of the foregoing, the override may be operable to move the electronic lock from the first state to the second state without drawing from any electrical power source.

In some embodiments according to any of the foregoing, the override may comprise an override actuator that comprises the linkage.

In some embodiments according to any of the foregoing, the assembly may comprise a first portion of the assembly. The first portion of the assembly may comprise at least part of the electronic lock. The assembly may also comprise a second portion of the assembly. The second portion of the assembly may comprise the anchor. The first portion of the system may be disengageable from the second portion of the system. The electronic lock may prevents disengagement of the first portion of the system from the second portion of the system when the electronic lock engages the anchor.

Additional embodiments and advantages of the disclosure will be set forth, in part, in the description that follows, and will flow from the description, or can be learned by practice of the disclosure.

It is to be understood that both the foregoing summary and the following detailed description are exemplary and explanatory only, and do not restrict the scope of the claims.

### BRIEF DESCRIPTION OF THE DRAWINGS

FIG. 1 is a diagram of an assembly comprising a lock system according to an aspect of the present disclosure.

FIG. 2 is a front elevation view of a unit comprising a lock system according to another aspect of the present disclosure.

FIG. 3 is a side elevation view of a portion of the unit of FIG. 2.

FIG. 4 is a side elevation view of an electronic lock according to an aspect of the present disclosure.

FIG. 5 is a partially cut-away oblique perspective view of the electronic lock of FIG. 4.

FIG. 6 is an oblique perspective view of an anchor compatible with the electronic lock of FIG. 4.

FIG. 7 is an oblique perspective view of an override switch of the electronic lock of FIG. 4.

FIG. 8 is an oblique perspective view of an end of an override actuator configured to connect to the electronic lock of FIG. 4.

FIG. 9 is an oblique perspective view of an assembly comprising the lever of FIG. 7 and the end of the override actuator of FIG. 8.

FIG. 10 is an oblique perspective view of a mechanical lock.

FIG. 11 is another oblique perspective view of the mechanical lock of FIG. 10 within a cut-away portion of a unit.

FIG. 12 is a partially cut-away oblique perspective view of a unit comprising a lock system according to an aspect of the present disclosure.

FIG. 13 is a side elevation view of an assembly comprising an electronic lock according to a further aspect of the disclosure.

FIG. 14 is a side elevation view of an assembly comprising an electronic lock according to a further aspect to the disclosure.

### DETAILED DESCRIPTION

The present invention will now be described in detail with reference to embodiments thereof as illustrated in the accompanying drawings. References to “one embodiment,” “an embodiment,” “an example embodiment,” “some embodiments,” etc., indicate that the embodiment described may include a particular feature, structure, or characteristic, but every embodiment described may not necessarily include that particular feature, structure, or characteristic. Similarly, other embodiments may include additional features, structures, or characteristics. Moreover, such phrases are not necessarily referring to the same embodiment. When a particular feature, structure, or characteristic is described in connection with the embodiment, it is submitted that it is within the knowledge of one skilled in the art to effect such feature, structure, or characteristic in connection with other embodiments whether or not explicitly described.

The terms “invention,” “present invention,” “disclosure,” or “present disclosure” as used herein are non-limiting terms and are not intended to refer to any single embodiment of the particular invention but encompasses all possible embodiments as described in the application.

Electronic locks, while useful, generally require a source of power to operate. In instances where electronic locks lose power, such as during a power outage or when the lock's battery becomes depleted, electronic locks may become inoperable. Depending on the state the state of the electronic lock without power, users may then be unable to secure or access facilities to which the electronic lock ordinarily controls access.

Providing an electronic lock with an override system that does not rely on the electronic lock's source of power can alleviate the above mentioned issues by enabling a user to move the electronic lock between a locked state and an unlocked state when the electronic lock does not have power. Mechanical override systems that can move the electronic lock between the locked state and unlocked state under the sole power of manual force applied by a user in the course of operating the override system can eliminate the loss of access or security in instances when electrical power is unavailable. Such mechanical override systems can be secured by mechanical locks compatible with conventional keys, enabling users accustomed to managing access with conventional keys to continue to use familiar methods of access management and lock operation with new lock systems according to some aspects of the present disclosure. Lock systems having overrides according to some aspects of the present disclosure can therefore enable electronic locks, and their associated advantages and workflows, to be implemented while maintaining advantages and workflows associated with mechanical locks.

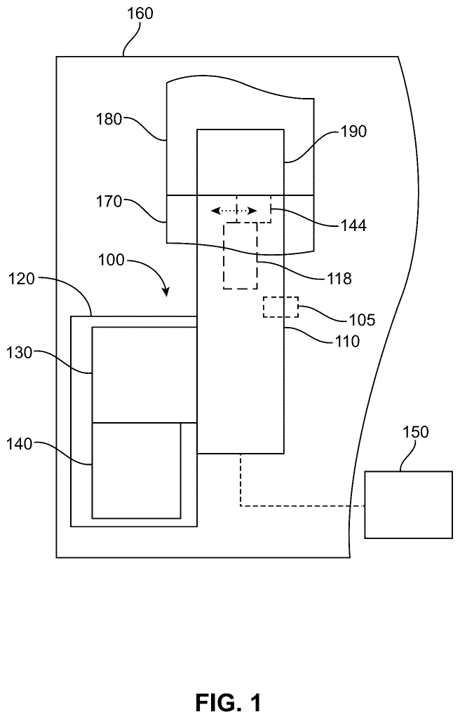

FIG. 1 shows an example of a lock system 100 according to an aspect of the present disclosure. Lock system 100 comprises an electronic lock 110 and an override 120. Electronic lock 110 is capable of transitioning reversibly between a first state and a second state. Electronic lock 110 comprises an electronic actuator 118 configured to cause electronic lock 110 to transition from the first state to the second state. Override 120 is also configured to cause electronic lock 110 to transition from the first state to the second state. In some examples, the first state is a locked state and the second state is an unlocked state. In other examples, the first state is an unlocked state and the second state is a locked state.

In some examples, electronic actuator 118 is governed by a controller 105. Controller 105 can be comprised by electronic lock 110. In other examples, controller 105 can be separate from electronic lock 110 but comprised by lock system 100. In further examples, controller 105 can be separate from lock system 100 but comprised by an assembly 160 in which lock system 100 is installed. Controller 105 can be configured to govern electronic actuator 118 to cause electronic lock 110 to transition between the locked state and the unlocked state in response to conditions detected by controller 105. Such conditions detected by controller 105 can comprise any one or any combination of receipt of wired or wireless communications from another electronic device, detection of a security token, detection of payment, detection of input of an access code or user credential, detection of a selection made at a user interface, and any other type of input upon which a controller can act.

Electronic lock 110 can comprise a retainer 114, wherein retainer 114 is movable by activation of electronic actuator 118, and the state of electronic lock 110 can depend on a position of retainer 114. Thus, electronic lock 110 can be configured to be in the first state when retainer 114 is in a first position and in the second state when retainer 114 is in the second position, and electronic actuator 118 can be configured to move retainer 114 from the first position to the second position. In such examples, override 120 can be configured to move retainer 114 from the first position to the second position, thereby causing electronic lock 110 to transition from the first state to the second state. In some further examples, override 120 can optionally also be configured to move retainer 114 from the second position to the first position, thereby causing electronic lock 110 to transition from the second state to the first state. In some further examples, electronic actuator 118 can optionally also be configured to move retainer 114 from the second position to the first position.

Override 120 can be a mechanical override. For example, override 120 can be a manually operable mechanical override configured to cause electronic lock 110 to transition from the first state to the second state powered solely by force applied to override 120 in the course of manually operating override 120. Features of override 120 for reversibly storing and releasing potential energy during manual operation of override 120, such as mechanical springs that alternate between two different compression states when override 120 is manually operated to alternate between two different positions, are not considered to be drawn from external sources in this context, or in the context of any other mechanical features described herein as being powered solely by manually applied force. Thus, while electronic lock 110 relies on a power source 150, such as, for example a power grid, building power, a battery, or any other source of electrical power, in order to activate electronic actuator 118 to cause electronic lock 110 to transition from the first state to the second state, override 120 according to some examples can cause electronic lock 110 to transition from the first state to the second state without receiving any power from power source 150. In further examples, override 120 can receive power from a backup source other than power source 150.

In some examples, electronic lock 110 can be configured to transition from the second state to the first state in the absence of action by electronic actuator 118 or override 120 toward the second state. Thus, in some such examples, electronic lock 110 can be configured to transition from the second state to the first state whenever electronic actuator 118 is inactive and no external activating force is applied to override 120.

In other examples, electronic lock 110 can be configured to remain in either the first state or the second state in the absence of action from electronic actuator 118 or override 120 causing electronic lock 110 to transition toward the other of the first state or the second state. In some examples wherein electronic lock 110 is configured to remain in either the first state or the second state in the absence of action from electronic actuator 118 or override 120, the electronic actuator 118 can be further configured to cause electronic lock 110 to transition from the second state to the first state. In some further examples, override 120 can be operable to cause electronic lock 110 to transition from the second state to the first state.

In some examples, override 120 can be incapable of opposing electronic actuator 118, such that when electronic actuator 118 is active and forcing electronic lock 110 into either the first state or the second state, override cannot affect the state of electronic lock 110. In other examples, override 120 can be configured to override electronic actuator 118 in only one direction, such that override 120 can force electronic lock 110 into the second state when electronic actuator 118 is active in such a way that would cause electronic lock 110 to be in the first state in the absence of action by override 120. In further examples, override 120 can be configured to override electronic actuator 118 in two directions such that use of override 120 can force electronic lock 110 into the first state or the second state and electronic actuator 118 is incapable of opposing override 120. Multiple options for constructing electronic lock 110 and override 120 to have any of the relationships to the first state, the second state, and one another described herein would be within the capabilities of one skilled in the art in view of the contents of the present disclosure.

The first state of electronic lock 110 can be a locked state while the second state of electronic lock 110 can be an unlocked state. Thus, electronic lock 110 can be configured to transition from a locked state to an unlocked state through activation of electronic actuator, and override 120 can be a backup mechanism for causing electronic lock 110 to transition from the locked state to the unlocked state. In other examples, the first state of electronic lock 110 can be an unlocked state while the second state of electronic lock 110 can be a locked state.

The locked state of electronic lock 110 can be a state wherein electronic lock 110 retains an anchor 190 or a state wherein electronic lock 110 is capable of retaining anchor 190 when electronic lock 110 and anchor 190 are appropriately positioned. The unlocked state of electronic lock 110 can be a state wherein electronic lock 110 is incapable of retaining anchor 190. In some examples, the unlocked stated of electronic lock 110 can be a state wherein electronic lock 110 cannot retain anchor 190 at any relative position between electronic lock 110 and anchor 190 allowed by an assembly that includes both electronic lock 110 and anchor 190 and constrains the movements of electronic lock 110 and anchor 190 with respect to one another.

Override 120 can comprise an override actuator 130 and an override lock 140. Override lock 140 can be a mechanical lock. Override actuator 130 can be connected to both electronic lock 110 and override lock 140. Override 120 can be configured such that override lock 140 prevents operation of override actuator 130 when override lock 140 is locked but permits operation of override actuator 130 when override lock 140 is unlocked. Thus, override 120 may be configured such that override lock 140 must be unlocked before override 120 can be used to change the state of electronic lock 110.

In some examples, override lock 140 may be configured such that a security token is required to unlock override lock 140. The security token can be, for example, a mechanical key, a radio frequency identification (RFID) tag, a key card, an external power source, or any other type of token capable of causing a lock to transition from a state wherein the lock cannot be unlocked to a state wherein the lock can be unlocked. In some examples wherein the security token is a mechanical key, override lock 140 can be a mechanical lock such that a user having the mechanical key can manually cause override lock 140 to transition from the locked state to the locked state without the mechanical key or override lock 140 drawing power from any source other than the force applied by the user to the mechanical key and override lock 140 in the course of manually operating override lock 140.

In some examples, override actuator 130 can be configured such that override lock 140 is a user interface for override actuator 130. Override actuator 130 can further be configured to transfer certain actions at override lock 140 to electronic lock 110. Thus, in some examples, lock system 100 can be configured so that unlocking override lock 140 unlocks electronic lock 110. In further examples, lock system 100 can be configured such that unlocking override lock 140 enables movement of a component of override lock 140, such as a handle, that is immovable when override lock is locked. Lock system 100 can further be configured such that movement of the handle of override lock 140 from a first position to a second, different position can cause override actuator 130 to force electronic lock 110 to change state.

An assembly 160 can comprise lock system 100. Assembly 160 can be, for example, a building, a gate, a padlock, a fixture, a unit of manufacture, a machine, or any other item wherein an electronic lock may be implemented. Assembly 160 can comprise a first portion 170 and a second portion 180. First portion 170 can comprise at least part of electronic lock 110. In some examples, first portion 170 can comprise part of electronic lock 110 but less than all of electronic lock 110. In further examples, first portion 170 can comprise all of electronic lock 110. In still further examples, first portion 170 can comprise all of lock system 100, including electronic lock 110 and override 120.

Second portion 180 can comprise anchor 190. As noted above, electronic lock 110 can be configured such that electronic lock 110 can retain anchor 190 when in the locked state and such that electronic lock 110 cannot retain anchor 190 when in the unlocked state. Thus, it may be possible to disengage first portion 170 from second portion 180 while electronic lock 110 is in the unlocked state, but impossible to disengage first portion 170 from second portion 180 while electronic lock 110 is in the locked state.

Retaining anchor 190 can be any engagement of anchor 190 by electronic lock 110 in a manner that prevents, within the constraints on the movement of anchor 190, first portion 170, and second portion 180 imposed by the structure of assembly, disengagement of anchor 190 from electronic lock 110 until electronic lock 110 transitions to the unlocked state. Thus, in some examples wherein anchor 190 is constrained to be movable relative to electronic lock 110 along a path, electronic lock 110 can comprise a retainer 114 in the form of a hook or jaw configured to obstruct a portion of the path behind anchor 190 when electronic lock 110 is in the locked state to restrict travel of anchor 190 away from electronic lock 110. In further examples, electronic lock 110 can comprise a retainer 114 configured to interlock with anchor 190, thereby restricting anchor's 190 mobility, when electronic lock 110 is in the locked state, and to unlock from anchor 190 when electronic lock 110 is in the unlocked state.

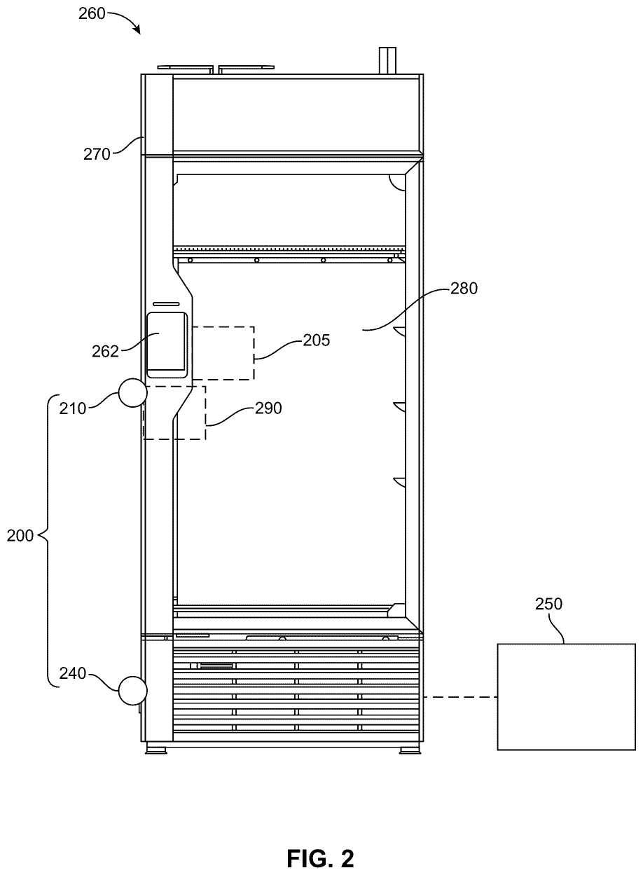

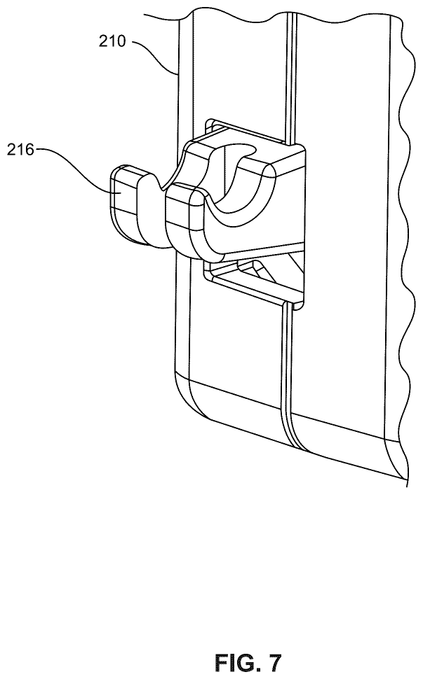

FIGS. 2-11 illustrate aspects of an assembly 260 comprising a lock system 200 according to an aspect of the present disclosure. Elements of assembly 260 are examples of like numbered elements of assembly 160 as described above. Thus, electronic lock 210 is an example of electronic lock 110 as described above, mechanical lock 240 is an example of override lock 140 as described above, and so on.

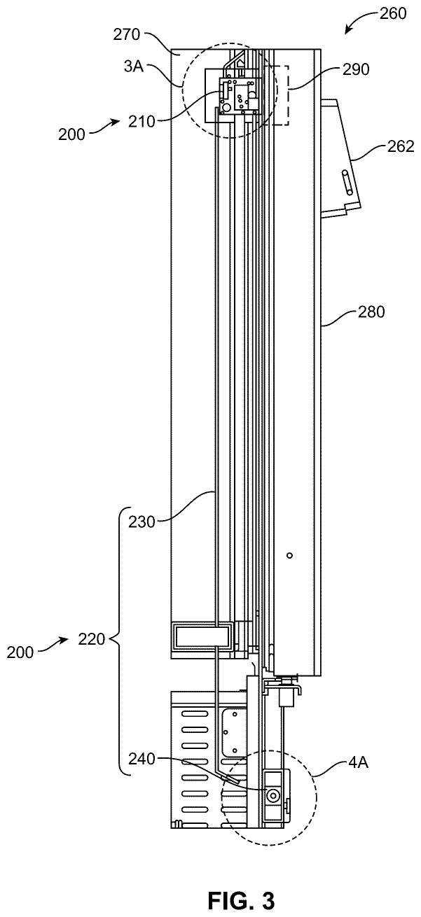

Referring to FIGS. 2 and 3, assembly 260 is a unit, specifically a machine, such as a cooler. Assembly 260 comprises a first portion 270 and a second portion 280. In the illustrated example, first portion 270 is a frame and second portion 280 is a door installed in the frame. Thus, frame 270 comprises at least part of an electronic lock 210 and door 280 comprises anchor 290. Within the context of assembly 260, the first portion may be referred to as “frame 270” or “first portion 270.” Within the context of assembly 260, second portion 280 may similarly be referred to as “door 280” or “second portion 280.”

In other examples, the definition of first portion 270 and second portion 280 within assembly 260 can be reversed such that the door comprises at least part of electronic lock 210 and the frame comprises anchor 290. In the illustrated example, first portion 270 or frame 270 comprises all of lock system 200. However, in other examples assembly 260 can comprise lock system 200 with first portion 270 or frame comprising less than all of lock system 200. While, in the illustrated example, first portion 270 is a frame and second portion 280 is a door, assemblies according to further examples can comprise a door that comprises a first portion and a frame that comprises a second portion as otherwise described herein.

Further according to the illustrated example, assembly 260 is a cooler defining a merchandise storage space. The merchandise storage space can be manually accessible through frame 270 when door 280 is disengaged from frame 270. However, door 280 can prevent manual access to the merchandise storage space when door 280 is closed within frame 270. Thus, when electronic lock 210 is in the locked position and retains anchor 290, it can be impossible to manually access the merchandise storage space defined within assembly 260.

Lock system 200 of assembly 260 comprises override 220 in addition to electronic lock 210. Override 220 comprises override actuator 230 and override lock 240. Override actuator 230 of the illustrated example comprises a mechanical linkage connecting override lock 240 to electronic lock 210.

Assembly 260 comprises a user interface 262 by which a user may gain access to merchandise stored within assembly 260. User interface 262 can comprise a payment interface. Thus, user interface 262 can comprise devices for accepting payment, such as, for example, any one or any combination of a magnetic card swipe slot, a chip reader, a bill slot, a coin slot, a wireless electronic communication unit configured to receive notification of electronic transactions, or any other device by which assembly 260 can be notified that a payment has been made. In the illustrated example, user interface 262 is a manually operable user interface configured to accept manual inputs, such as button presses or touchscreen inputs. In other examples, user interface 262 can comprise an electronic communication unit configured to accept inputs, payments, or both inputs and payments in the form of communications from another electronic device, such as a smart phone. In some examples wherein user interface 262 comprises an electronic communication unit configured to accept inputs, payments, or both inputs and payments in the form of communications from another electronic device, user interface 262 can lack any mechanism for receiving direct manual input or payment.

In some examples, assembly 260 can be configured to selectively lock or unlock electronic lock 210 based on usage of user interface 262. For example, assembly 260 can be configured to activate an electronic actuator 218 of electronic lock 210 to cause electronic lock 210 to transition from the locked state to the unlocked state in response to receipt of payment or a payment authorization by a payment interface comprised by user interface 262. For example, assembly 260 can be configured to activate electronic actuator 218 to unlock electronic lock 210 in response to presentation of a card to a card reader of user interface 262, detect opening and closing of door 280 following activation of electronic actuator 218, detect what merchandise was removed from the merchandise storage space when door 280 was open, and then to charge the card for the removed merchandise. In further examples, assembly 260 can be configured to activate electronic actuator 218 to unlock electronic lock 210 in response to transmission of a user account identifier to an electronic communication unit of user interface 262, detect opening and closing of door 280 following activation of electronic actuator 218, detect what merchandise was removed from the merchandise storage space when door 280 was open, and then to charge the user account for the removed merchandise.

Assembly 260 can comprise a controller 205 for governing operation of electronic actuator 218. In some examples, controller 205 can be configured to respond to inputs at user interface 262 by activating or deactivating electronic actuator 218. In further examples, controller 205 can be configured to respond to communications from other devices, such as wireless communications from an external device, by activating or deactivating electronic actuator 218. In further examples, controller 205 can also govern user interface 262, such as by processing inputs to user interface 262 and generating outputs to be displayed or otherwise made apparent by user interface 262.

Assembly 260 draws power from an external power source 250. External power source 250 can be, for example, building power, a power grid, a generator, or an external battery. In other examples, power source 250 can be an internal power source such as a battery comprised by assembly 260. Assembly 260 relies on power source 250 to power electronic lock 210. Assembly 260 according to some examples can also rely on power source 250 for other functions, such as powering user interface 262. In further examples, including some wherein assembly 260 is a cooler stocked with cooled products, assembly 260 can be configured to refrigerate the merchandise storage space and can use power source 250 to power a refrigeration system for that purpose.

Whereas assembly 260 relies on power source 250 to power electronic lock 210, and electronic actuator 218 in particular, override 220 does not rely on power source 250. Thus, override 220 can enable transition of electronic lock 210 from a locked state to an unlocked state even when power source 250 is unavailable.

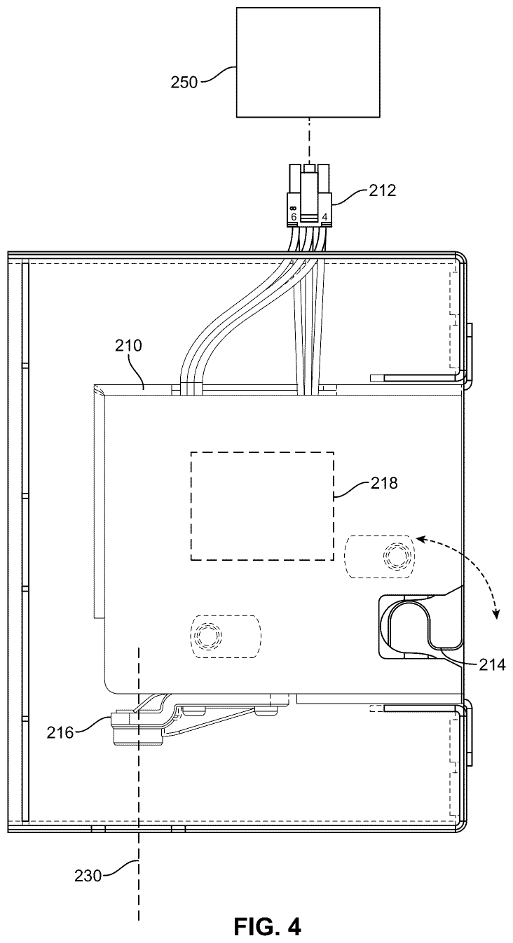

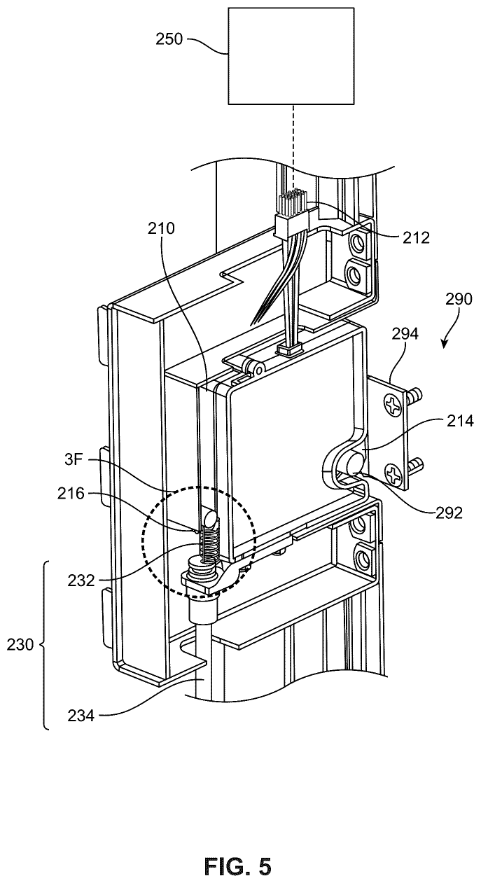

Turning to FIGS. 4-6, electronic lock 210 comprises a retainer 214 configured to engage anchor 290. Retainer 214 of the illustrated example is a single hook shaped jaw movable by electronic actuator 218 between a first, locked position wherein retainer 214 extends behind a pin 292 of anchor 290 as shown in FIG. 5 and a second, unlocked position wherein retainer 214 is clear of anchor 290. Electronic lock 210 can further comprise an adaptor 212 connecting electronic lock 210 to power source 250 so that electronic actuator 218 can receive power from power source 250. Anchor 290 further comprises a base 294 and a bridge 296 that connects base 294 to pin 292. Base 294 is configured to secure anchor 290 to a remainder of door 280. For example, base 294 may comprise fastener holes. In further examples, base 294 may comprise other features for facilitating connection of base 294 to another part of door 280. Pin 292 may optionally be adjustable in position or length relative to bridge 296. For example, pin 292 may be provided as a bolt threadedly engaged with an opening formed through bridge 296 to enable adjustment by turning pin 292 relative to bridge 296. This adjustability may increase positioning tolerances during installation and facilitate efficient tuning and maintenance of the unit.

The position of anchor 290 relative to electronic lock 210 shown in FIG. 5 is the position of anchor 290 relative to electronic lock 210 when door 280 is closed within frame 270, thereby engaging frame 270 and preventing manual access to the merchandise storage space. In the illustrated embodiment, assembly 260 constrains movement of door 280, which comprises anchor 290, relative to frame 270, which comprises electronic lock 210, such that door 280 swings relative to frame 270. In particular, to disengage door 280 from frame 270 by opening door 280 to enable manual access to the merchandise storage space, door 280 must swing such that bridge 296 of anchor 290 passes through a space occupied by retainer 214 in FIG. 5. Thus, when door 280 engages frame 270 and electronic lock 210 is in the locked state as shown in FIG. 5, retainer 214 engages anchor 290. Moreover, when door 280 engages frame 270 and electronic lock 210 is in the locked state as shown in FIG. 5, retainer 214 retains anchor 290 by retains anchor 290 by obstructing a portion of a path along which anchor 290 must move for door 280 to disengage frame 290. When electronic lock 210 transitions from the locked state to the unlocked state, retainer 214 moves clear of anchor 290 such that anchor 290 is free to swing away from electronic lock 210, enabling door 280 to disengage from frame 270. In some examples, door 280 can remain movably connected to frame 270 at some location or locations remote from anchor 290 when disengaged from frame 270 as described above. Thus, after disengaging from frame 270 as described above, door 280 can slide or pivot relative to frame 270 without becoming completely disconnected from frame 270. In other examples, door 280 can be completely disconnected from frame 270 upon disengaging from frame 270 as described above.

In other examples, the structures of retainer 214 and anchor 290 can in complement to one another and various movement paths available to the frame 270 and door 280 in other variations on assembly 260. Thus, in other examples, retainer 214 can comprise, for example, a pair of jaws, a tab, a bolt, or any other structure engageable to an anchor to prevent separation of anchor 290 from electronic lock 210. In other examples, anchor 290 can comprise, for example, a pin with a notch, a hook, a bolt, or any other structure engageable by a retainer to prevent separation of anchor 290 from electronic lock 210.

Returning to FIGS. 4, 5, and 7, electronic lock 210 comprises an override switch 216. Override switch of the illustrated example 216 is a lever, but can be other mechanisms in other examples. Override switch 216 is an element comprised by electronic lock 210 with electronic lock 210 being configured to transition from the locked state to the unlocked state in response to operation of override switch 216 without activation of electronic actuator 218. Thus, electronic lock 210 can be configured such that, when electronic lock 210 is in the locked state shown in FIG. 5, operation of override switch 216 causes retainer 214 to move from a first position shown in FIG. 5 to a second position wherein retainer 214 is clear of the movement path of anchor 290 without activation of electronic actuator 218. Electronic lock 210 can be configured such that operation of override switch 216 moves retainer 214 mechanically, without relying on any source of power other than force applied to override switch 216. Electronic lock 210 can optionally also be configured such that operation of override switch 216 can cause electronic lock 210 to transition from the second, unlocked state to the first, locked state. In some examples, electronic lock 210 can optionally also be configured such that electronic actuator 218 can cause retainer 214 to move from the first position to the second position without affecting the position of override switch 216. A skilled person having reviewed the present disclosure would be able to devise and construct numerous structures that would relate the position of retainer 214 to operation of override switch 216 as described herein.

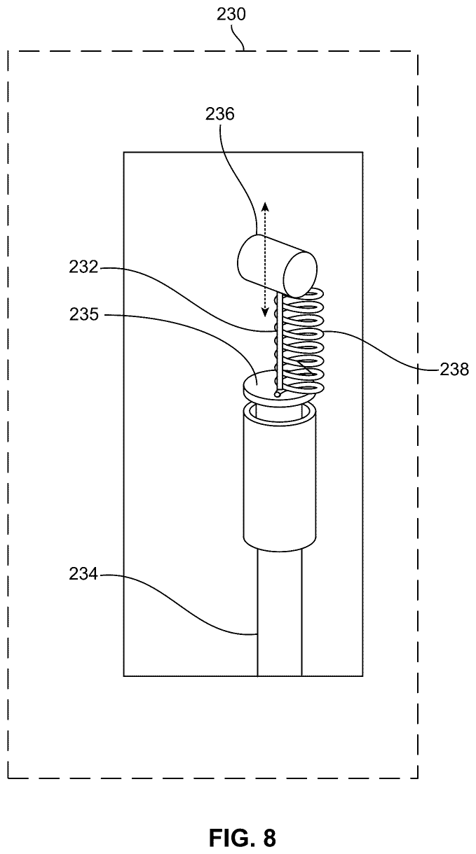

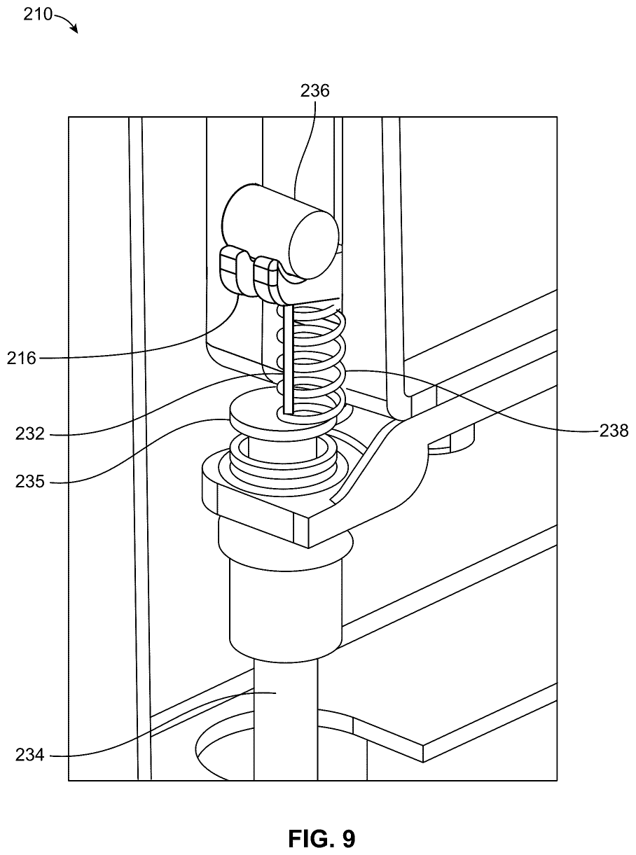

Turning to FIGS. 8 and 9, override actuator 230 can comprise a cable 232 that comprises a connector 236. Connector 236 is configured to connect cable 232 to override switch 216 such that override switch 216 can be operated by moving cable 232. In the illustrated example, cable 232 extends through a slot defined in override switch 216 and connector 236 connects cable 232 to override switch 216 by having the form of a body that is too large to pass through the slot. Thus, with connector 236 resting on override switch 216 as shown in FIG. 9, override switch 216 can be operated in a first direction by applying tension to cable 232 through the slot so that connector 236 forces override switch 216 to move.

Override switch 216 can be biased to operate in a second direction opposite from the first direction in the absence of sufficient force applied by override actuator 230 in the first direction. In the illustrated example, override actuator 230 further comprises a platform 235 and a spring 238. Cable 232 may extend past or through platform 235 to connector 236. Platform 235 is configured to have a fixed position within assembly relative to electronic lock 210. Spring 238 is positioned to bias override switch 216 away from platform 235. Thus, after override switch 216 has been operated in the first direction by applying tension to cable 232 to move switch 216 toward platform 235, override switch 216 can be operated in a second, opposite direction by reducing the tension on cable 232 to allow spring 238 to force switch 216 away from platform 235. Platform 235 and spring 238 of the illustrated example therefore bias override switch 216 to operate in the second direction in the absence of sufficient force applied by override actuator 230 in the first direction. In other examples, electronic lock 210 or override actuator 230 can comprise features instead of or in addition to platform 235 and spring 238 to bias override switch 216 to operate in the second direction. Because cable 232 is connected to override switch 216 and spring 238 biases override switch 216, spring 238 also provides a bias that acts on cable 232.

In some examples, electronic lock 210 can be configured such that operating override switch 216 in the first direction by applying tension to cable 232 forces electronic lock 210 into the unlocked state. Electronic lock 210 can further be configured such that operating override switch 216 in the second direction enables electronic lock 210 to return to the locked state without forcing electronic lock 210 into the locked state. Electronic lock 210 can be configured such that retainer 214 is biased toward the first position of retainer 214 shown in FIGS. 4 and 5 independently of the bias on override switch 216 in the second direction. In some such examples, the bias on retainer 214 toward the first position shown in FIGS. 4 and 5 can be overcome by either operation of the override switch 216 or activation of electronic actuator 218 individually to move electronic lock 210 into the unlocked state, meaning the bias on retainer 214 will return electronic lock 210 to the locked state only when neither electronic actuator 218 nor override switch 216 overcomes the bias to keep retainer in the second position.

Override actuator 230 of the illustrated example further comprises a sleeve 234. Sleeve 234 guides cable 323. In some examples, cable 232 can be a relatively stiff and incompressible cable generally constrained by sleeve 234 such that cable 232 and sleeve 234 cooperate to form a Bowden cable assembly, wherein movement of override switch 216 connected at one end of cable 232 in either direction corresponds with proportional movement of a portion of a body 241 of override lock 240 connected at another end of cable 232.

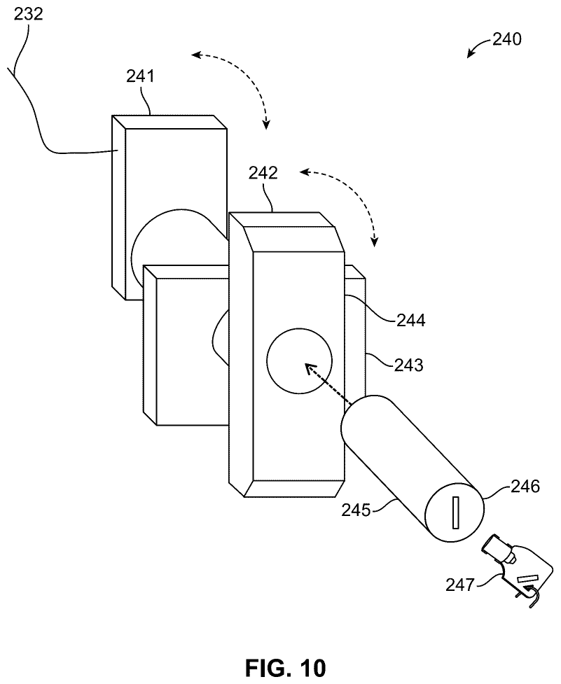

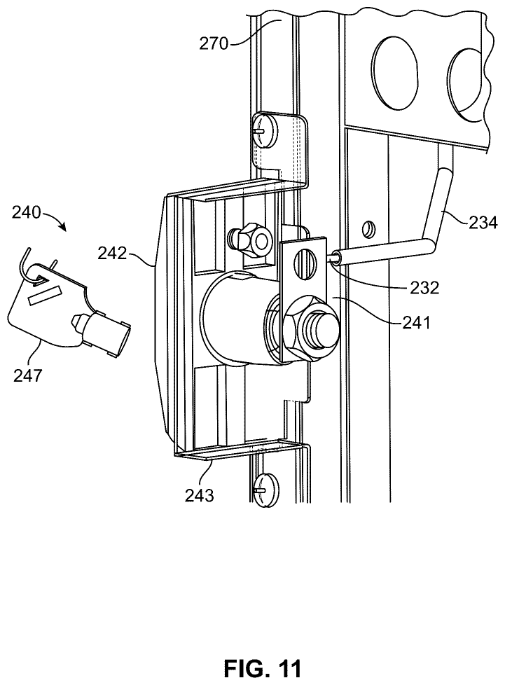

FIGS. 10 and 11 show override lock 240. Override lock 240 of the illustrated example comprises a body 241 connected to cable 232. Body 241 is movable by operation of override lock 240, so operation of override lock 240 can be used to increase or decrease tension on cable 232.

Cable 232 can be connected to body 241 in any of a variety of ways. For example, body 241 may comprise a fastener configured to clamp an end of cable 232. In another example, cable 232 may comprise a loop configured to receive a protrusion of body 241. Cable 232 may be connected to body 241 in a way that enables adjustment of slack in cable 232. For example, a fastener of body 241 may be selectively releasable to enable an operator to choose which point along cable 232 is fastened to body 241. In another example, a loop of cable 232 may be formed by a fastener configured to fasten two points on cable 232 together, wherein the fastener allows an operator to select one or both of the two fastened points.

Override lock 240 further comprises a base 243 that connects override lock 240 to assembly 260. Base 243 secures override lock's 240 location within assembly 260 so that movement of other elements of override lock 240 relative to base 243 is also movement relative to certain other parts of assembly 260. Thus, movement of body 241 relative to base 243 is also movement of body 241 relative to sleeve 234. Body 241 of the illustrated example is a lever, but can be other mechanisms in other examples. Body 241 of the illustrated example is also pivotably connected to base 243, so pivoting of body 241 relative to base 243 causes an end of body 241 to move relative to sleeve 234. Pivoting body 241 relative to base 243 can therefore affect tension on cable 232 can cause cable 232 to slide within sleeve 234. Body 241 according to other examples can be movable in different ways relative to base 243, such as by sliding laterally or longitudinally.

Override lock 240 also comprises a handle 242 to facilitate manual operation of override lock 240, including manual control of movement of body 241. Thus, handle 242 is configured to move relative to base 243 in a manner corresponding to movement of body 241 relative to base 243. In the illustrated example, handle 242 is pivotably connected to base 243 such that pivoting handle 242 relative to base 243 causes corresponding pivoting of body 241 relative to base 243. Movement of handle 242 relative to base 243 can vary in other examples in the same ways that movement of body 241 relative to base 243 can vary in other examples.

Handle 242 facilitates manual control of override 220. Override 220 can be configured to mechanically cause electronic lock 210 to transition between the first, locked state to the second, unlocked state powered solely by force applied manually to handle 242.

Override lock 240 is configured to transition reversibly between a mobile state, and an immobile state. In the mobile state, wherein handle 242 can be used to move body 241 relative to base 243, while in the immobile state, handle 242 cannot be used to move body 241 relative to base 243. Override lock 240 can be configured to immobilize either or both of handle 242 and body 241 relative to base 243 in the immobile state. Thus, when override lock 240 is in the mobile state, override 220 is in an operable state, and when override 240 is in the immobile state, override 220 is in an inoperable state. The mobile state can further be an unlocked state of override lock 240, while the immobile state can further be a locked state of override lock 240. Override lock 240 can be configured to require the presence of a security token 247 to enter the mobile state. For example, override lock 240 can be configured to only enter the mobile state when engaged by security token 247. Security token 247 can be, for example, a key.

Override lock 240 of the illustrated example is a mechanical lock. Thus, override lock 240 is configured to require a security token 247 in the form of a mechanical key to unlock. Moreover, override lock 240 of the illustrated example is configured to transition mechanically between the locked and unlocked states powered solely by force applied to override lock 240 in the manual engagement and disengagement of override lock 240 with mechanical key 247.

In examples wherein override lock 240 is a mechanical lock, override lock 240 further comprises a tumbler configured complementarily to mechanical key 247. That is, override lock 240 according to such examples comprises a tumbler configured to be locked and unlocked only by unique features of mechanical key 247 and copies of mechanical key 247. Override lock 240 of the illustrated example comprises a barrel 245 that contains the tumbler. A keyhole 246 can be defined in barrel 247 through which mechanical key 247 can engage the tumbler. Barrel 247 is installable in a receptacle of mechanical lock 240.

Barrel 245 in some examples can be of a type already commercially available and usable in other locks. Thus, a user of lock system 200 can select a barrel 245 to be installed in lock system 200 based on desired characteristics for barrel 245 that can be selected separately from lock system 200, such as compatibility with keys that the user already relies on to lock and unlock other items. For example, some users may operate a large number of items, such as coolers or vending machines, many of which have only mechanical locks. Some such users may have configured some or all such mechanical locks to be compatible with a single key. Some such users may phase in electronically lockable items having lock system 200 installed. To use the same key with override lock 240 as used with the preexisting, purely mechanical locks, a user may obtain barrels 245 matching barrels installed in the preexisting, purely mechanical locks and install the barrels 245 in the new lock systems 200. Similar workflows can also be used to phase in lock systems 200 into other machines and facilities.

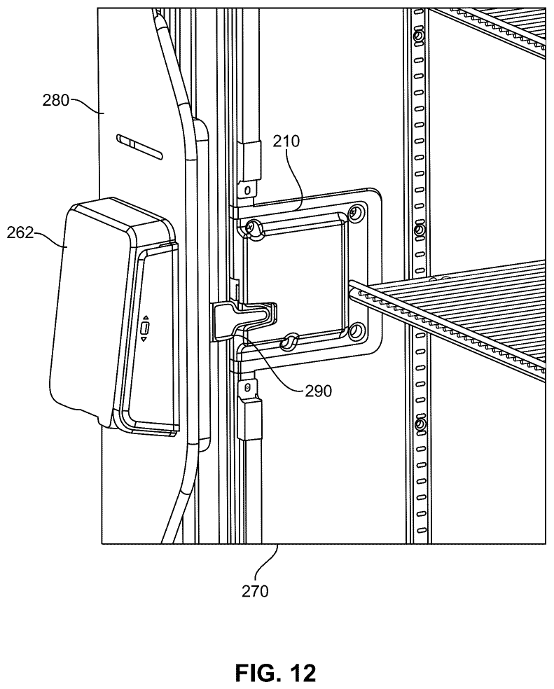

As shown in FIG. 12, electronic lock 210 can be mounted to frame 270 to be accessible from a space to which electronic lock 210 controls access. In the illustrated example, wherein assembly 260 is a cooler, electronic lock 210 can be mounted to an interior of frame 270 to be accessible from an interior of the cooler that may be accessed by opening door 280. Door 280 is transparent in FIG. 12, showing that electronic lock 210 is mounted to an interior facing side of frame 270. Electronic lock 210 is therefore accessible from an interior space of cooler assembly 260 in which products may be stored.

Mounting electronic lock 210 to frame 270 to be accessible from a space to which electronic lock 210 controls access can eliminate the need for external access panels on frame 270. This can allow for designs, logos, and branding placed on the exterior of frame 270 to have an unbroken appearance. Additionally, compared to arrangements wherein electronic lock 210 may be accessible through external access panels, mounting electronic lock 210 to be accessible instead from a space to which electronic lock 210 controls access may provide an additional layer of security to prevent tampering, since electronic lock 210 must be unlocked before it can be accessed.

Locks other than the electronic locks with mechanical overrides described herein may also be incorporated into assemblies wherein the lock is accessible from spaces to which controls access. However, this configuration is particularly suitable for electronic locks 210 with manual overrides because manual overrides provide an alternative way for authorized personnel to access electronic lock 210. This can be useful, for example, if maintenance to a lock is necessary when electronic components of the lock have failed or power is unavailable. To access an internally-mounted electronic lock 210 in such circumstances, an authorized user may simply operate the mechanical override to unlock door 280 from frame 270 and access electronic lock 210 without relying on power or operation of any electronic systems. Without a mechanical override, it would be significantly more difficult to access an inoperable internally-mounted lock.

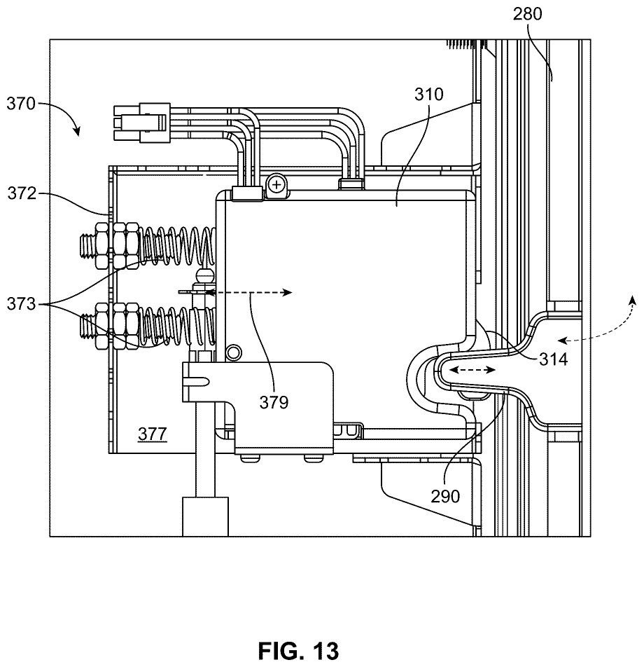

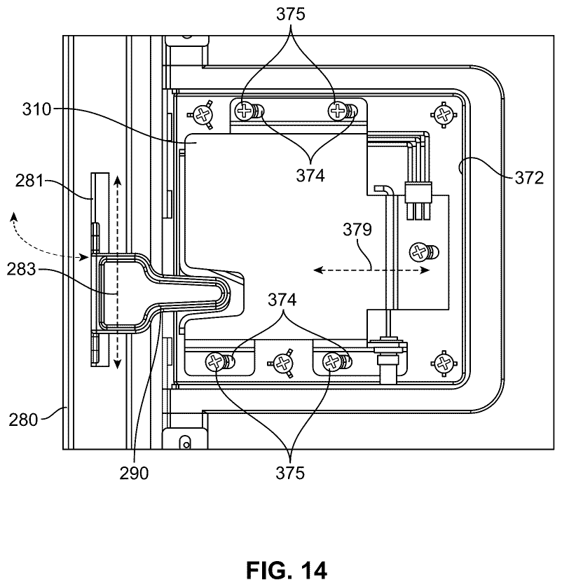

FIGS. 13 and 14 show an electronic lock 310 in a first portion 370 according to a further embodiment. Electronic lock 310 and first portion 370 can be alike in all respects to the electronic locks 110, 210 and first portions 170, 270 according to any of the other embodiments illustrated or described elsewhere herein. Thus, electronic lock 310 and first portion 370 can be integrated into the above described lock systems 100, 200, and in some embodiments, first portion 370 can be a frame of a cooler. Further, electronic lock 310 and first portion 370 can be implemented within assembly 260. Similarly, numbered elements in electronic lock 310 and first portion 370 may be alike to like numbered elements in electronic locks 110, 210 and first portions 170, 270. Thus, electronic lock 310 may comprise a retainer 314 alike to retainers 114, 214.

Electronic lock 310 is movable within first portion 370 and biased relative to other features of first portion 370. First portion 370 can include a seat 372 relative to which electronic lock 310 is biased. First portion 370 can further comprise one or more biasing elements 373 configured to bias electronic lock 310 relative to seat 372. In some examples, biasing elements 373 can be resilient biasing elements. In further examples, biasing elements 373 can be any structure capable of biasing electronic lock 310 relative to seat 372, such as, for example, mechanical springs, including coil springs as shown in the illustrated example.

Electronic lock 310 can be movable within first portion 370 along a lock translation axis 379 along which electronic lock 310 receives force from anchor 290 when anchor 290 is engaged or disengaged from electronic lock 310. In some further embodiments, electronic lock 310 may be movable relative to another feature of first portion 370 along a lock translation axis 379 parallel to a force component comprising a majority of the force anchor 290 applies to electronic lock 310 when anchor 290 moves into engagement with electronic lock 310. For example, when electronic lock 310 and first portion 370 are implemented within system 200, anchor 290 may be comprised by a second portion in the form of door 280. Door 280 may swing shut such that anchor 290 travels on an arcuate path when approaching electronic lock 310. Thus, lock translation axis 379 may be parallel to a line tangent to the path of anchor 290 at a point at or near where anchor 290 may be received by retainer 314. In such embodiments, anchor 290 may apply force to electronic lock 310 when moving into engagement with electronic lock 310, and at least a portion of that force may be along lock translation axis 379. In embodiments where lock translation axis 379 is parallel to a line tangent to the path of anchor 290 at a point at or near where anchor 290 meets electronic lock 310 when engaging electronic lock 310, lock translation axis 379 will be parallel to a force component comprising a majority of the force anchor 290 applies to electronic lock 310 when anchor 290 moves into engagement with electronic lock 310.

The bias on electronic lock 310 relative to other features of first portion 370 can also be along lock translation axis 379. In some such embodiments, the ability of electronic lock 310 to move within first portion 370 along lock translation axis 379 and the bias along lock translation axis 379 can cooperate to move electronic lock 310 to a best position for receiving anchor 290. In some such embodiments, the biased movement of electronic lock 310 can compensate for irregularities in the installation of anchor 290 or other portions of assembly 260, thereby enabling effective engagement between anchor 290 and electronic lock 310 and secure closure of door 280 without requiring a degree of precision that would be difficult to achieve when installing lock system 200 in assembly 260. This self-correcting tendency can also reduce the need for access panels typically used for adjusting the position of locking features in some coolers and similar assemblies. Reducing the number of access panels may improve the overall appearance of the assembly by creating a sleeker look or providing greater unbroken surface area for logos and other decorations.

The force of the bias on electronic lock 310 relative to seat 372 can be insufficient to overcome the closing force applied by any features of assembly 260 that hold door 280 closed. For example, in some embodiments wherein assembly 260 is a cooler, assembly 260 may comprise a magnetic arrangement configured to hold door 280 closed, a mechanical seal that applies a friction-fit to door 280 when door 280 is closed, or any combination of features that cooperate to hold door 280 closed to prevent the escape of cold air from the interior of assembly 260. In some such arrangements, the force biasing electronic lock 310 relative to seat 372 can be insufficient to overcome the total closing force of the magnetic arrangement, mechanical seal, or other features that cooperate to hold door 280 closed. The advantages associated with the movable, biased electronic lock 310 can therefore be achieved without interfering with the normal closing and sealing function of door 280.

First portion 370 can include a base 377, and electronic lock 310 can be movably connected to base 377. First portion 370 can include a track 374 and a slider 375 that movably connect electronic lock 310 to base 377. Slider 375 is connected to track 374 and movable along track 374. Track 374 can comprise, for example, a slot formed in another element, such as a slot formed in base 377 or a slot formed in a housing of electronic lock 310. In further embodiments, track 374 can additionally or instead comprise a distinct structure configured to movably connect to slider 375. Slider 375 can be any element movably connectable to track 374, such as a fastener that extends through a slot comprised by track 374. In various embodiments, base 377 can comprise either track 374 or slider 375, while electronic lock 310 can comprise the other of track 374 or slider 375. For example, in some embodiments, base 377 comprises track 374 and electronic lock 310 comprises slider 375. In the illustrated embodiment, for example, electronic lock 310 comprises tracks 374 and base 377 comprises sliders 375. In further embodiments, electronic lock 310 may comprise slider 375 and base 377 may comprise tracks 374.

The one or more tracks 374 and sliders 375 connecting electronic lock 310 to base 377 can constrain movement of electronic lock 310 relative to base 377 to translation along lock translation axis 379. For example, in some embodiments wherein multiple tracks 374 extend parallel to lock translation axis 379 and are each engaged with a respective one of multiple sliders 375, as shown in the illustrated embodiment of FIGS. 13 and 14, electronic lock 310 may be prevented from rotating relative to base 377 but able to translate along lock translation axis 379 relative to base 377. Movement of electronic lock 310 relative to base 377 in the illustrated embodiment is thus constrained to translation along lock translation axis 379.

In the illustrated embodiment, seat 372 comprises a surface extending away from base 377. In some embodiments, seat 372 can be integrally formed with base 377. In further embodiments, seat 372 can be separate from base 377. In further embodiments, base 377 can comprise seat 372. In some embodiments, the bias on electronic lock 310 along lock translation axis 379 can be created by placing biasing elements 373 between electronic lock 310 and seat 372 relative to a direction parallel to lock translation axis 379. In further embodiments, the bias on electronic lock 310 along lock translation axis 379 can be created by tracks 374 and sliders 375 constraining motion of electronic lock 310 to translation along lock translation axis 379 in combination with arranging biasing elements 373 to bias electronic lock 310 to a particular position along the range of motion permitted by tracks 374 and sliders 375.

FIG. 14 shows that anchor 290 may also be configured to translate along an anchor translation axis 283. Anchor translation axis 283 may be defined relative to door 280. Anchor translation axis 283 may be defined with respect to second portion such that when door 280 engages first portion 370 and retainer 314 receives anchor 290, anchor translation axis 283 is perpendicular to lock translation axis 375. Electronic lock 310 and anchor 290 may therefore be translatable in complementary directions, thereby providing two degrees of freedom for dynamic adjustability of the locking system that comprises first portion 370 and door 280. This can lessen the precision necessary to install electronic lock 310 and anchor 290 for effective locking. The translatable electronic lock 310 and translatable anchor 290 of the illustrated example thus cooperate with one another to provide better results than either could individually. However, in other embodiments, translatable electronic lock 310 can be implemented with a non-translating anchor, and translating anchor 290 can be implemented with a non-translating electronic lock 310.

Door 280 can comprise a slot 281 for anchor 290 to translate along. Accordingly, slot 281 may extend parallel to anchor translation axis 283. In some embodiments, slot 281 may be configured to constrain anchor's 290 movement to translation along anchor translation axis 283.

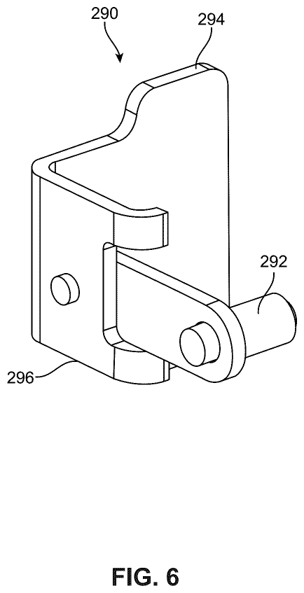

Anchor 290 and door 280 can be provided with features to facilitate translation of anchor 290 along anchor translation axis 283. Thus, for example, anchor 290 may comprise tracks defined in base 294, shown in FIG. 6, and anchor 290 may be connected to the remainder of door 280 by fasteners slidably received in the tracks. Anchor 290 may also be biased to a position along anchor translation axis 283 by a biasing element, such as any of the types of biasing elements described above with respect to the biasing elements 373 of first portion 370.

It is to be appreciated that the Detailed Description section, and not the Summary and Abstract sections, is intended to be used to interpret the claims. The Summary and Abstract sections may set forth one or more but not all exemplary embodiments of the present disclosure but are not intended to limit the present disclosure and claims in any way.

The foregoing description of the specific embodiments so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the claims and their equivalents.

What is claimed is:

1. A lock system comprising:
an electronic lock comprising an electronic actuator and a retainer, wherein the electronic actuator is configured to move the retainer from a first position to a second position;
a mechanical lock comprising a body, wherein the mechanical lock is configured to transition from an immobile state to a mobile state when engaged by a key, the body is movable from a third position to a fourth position when the mechanical lock is in the mobile state, and the body is not movable from the third position to the fourth position when the mechanical lock is in the immobile state; and
an override actuator connected to the mechanical lock and the electronic lock, wherein the override activator is configured to move the retainer from the first position to the second position when the body moves from the third position to the fourth position.

2. The lock system of claim 1, wherein the mechanical lock comprises a lever configured to rotate when the body moves from the third position to the fourth position, and the override actuator is connected to the lever.

3. The lock system of claim 2, wherein the override actuator comprises a cable connected to the lever.

4. The lock system of claim 3, wherein the override actuator comprises a sleeve through which the cable extends such that the sleeve and the cable form a Bowden cable.

5. The lock system of claim 4, wherein the retainer is configured to return from the second position to the first position when the body moves from the fourth position to the third position if the electronic actuator is inactive.

6. The lock system of claim 1, wherein the lock system is configured to move the retainer from the second position to the first position when the body moves from the fourth position to the third position.

7. The lock system of claim 6, wherein the retainer is biased toward the first position.

8. The lock system of claim 7, wherein the override actuator is biased toward a position allowing the retainer to return from the second position to the first position.

9. The lock system of claim 8, comprising a spring, wherein the override actuator comprises a cable, and a bias on the override actuator is provided by the spring acting on the cable.

10. A unit comprising:
the lock system of claim 1;
an anchor;
a first portion; and
a second portion; wherein:
the retainer is configured to engage the anchor when the first portion contacts the second portion and the retainer is in the first position,
the retainer is configured to prevent the first portion from moving out of engagement with the second portion when the retainer engages the anchor, and
the retainer is configured to disengage the anchor when the retainer moves from the first position to the second position.

11. The unit of claim 10, wherein the unit is a cooler comprising:
a merchandise storage space;
a payment interface;
a frame comprising the first portion of the unit; and
a door comprising the second portion of the unit, wherein the door is configured to prevent manual access to the merchandise storage space when the retainer engages the anchor and to enable manual access to the merchandise storage space when the first portion is out of contact with the second portion.

12. The unit of claim 11, wherein either the first portion or the second portion comprises the anchor and the other of the first portion or the second portion comprises the retainer of the electronic lock.

13. The unit of claim 11, wherein the unit is configured to activate the electronic actuator to move the retainer to the second position in response to receipt of a payment or payment authorization by the payment interface.

14. The unit of claim 10, wherein:
the first portion comprises a frame, the electronic lock is movably mounted to the frame, and the electronic lock is biased relative to the frame; or
the second portion comprises a door, the anchor is movably mounted to the door, and the anchor is biased relative to the door.

15. An assembly comprising:
an electronic lock configured to electronically move between a first state, wherein the electronic lock engages an anchor, and a second state, wherein the electronic lock does not engage the anchor; and
an override comprising a mechanical linkage connected to the electronic lock, wherein the override is manually operable to move the electronic lock from the first state to the second state by action of the mechanical linkage.

16. The assembly of claim 15, wherein:
the override is configured to be in an inoperable state when a security token is absent, the inoperable state preventing manual operation of the override to move the electronic lock from the first state to the second state, and
the override is configured to move from the inoperable state to an operable state when the security token is presented to the override.

17. The assembly of claim 16, wherein:
the security token is a mechanical key,
the override comprises a mechanical tumbler configured complementarily to the mechanical key, and
the override is configured to move from the inoperable state to the operable state when the mechanical key is presented to the override by being placed into engagement with the mechanical tumbler.

18. The assembly of claim 15, wherein the override is operable to move the electronic lock from the first state to the second state without drawing from any electrical power source.

19. The assembly of claim 15, wherein the override comprises an override actuator that comprises the linkage.

20. The assembly of claim 15, comprising:
a first portion of the assembly, wherein the first portion of the assembly comprises at least part of the electronic lock; and
a second portion of the assembly, wherein the second portion of the assembly comprises the anchor; wherein
the first portion of the system can be disengaged from the second portion of the system, and
the electronic lock prevents disengagement of the first portion of the system from the second portion of the system when the electronic lock engages the anchor.
